(19) United States
(12) Patent Application Publication
(10) Pub. No.: US 2025/0200565 A1
(43) Pub. Date: Jun. 19, 2025

(54) MESSAGING APPLICATION-BASED TASK WORKFLOWS

(71) Applicant: WhatsApp LLC, Menlo Park, CA (US)

(72) Inventors: Xinyi Guo, London (GB); Rajalingappaa Shanmugamani, London (GB); Sandro Paganotti, London (GB)

(21) Appl. No.: 18/545,755

(22) Filed: Dec. 19, 2023

(51) Int. Cl. G06Q 20/38; G06F 9/54

(52) U.S. Cl. CPC G06Q 20/3827; G06F 9/546

(57) ABSTRACT

As disclosed herein, a computer-implemented method is provided. In one aspect, the computer-implemented method may include receiving, in a message thread of a messaging application associated with a communication network, a request from a user of the messaging application, wherein the message thread includes at least the user and a supplier. The computer-implemented method may include displaying to the user, based on the request, a message prompting the user for a confirmation to initiate a transaction with the supplier for an item offered by the supplier. The computer-implemented method may include retrieving, based on the confirmation, a transaction workflow associated with the supplier. The computer-implemented method may include displaying, in the message thread of the messaging application, the transaction workflow in an interactive display. A system and a non-transitory computer-readable storage medium are also disclosed.

### BACKGROUND

### Field

The present disclosure is generally related to messaging (or “chat”) applications. More specifically, the present disclosure relates to customer interactions with businesses in message threads of messaging applications.

### Related Art

Businesses rely on conversations with customers. These conversations allow businesses to build relationships, conduct market research, resolve problems, mold brand reputation, tailor marketing and sales, and gain a competitive advantage by demonstrating a dedication to responsiveness and customer satisfaction. Many types of technology support these conversations, including telephone, email, website chatbots, online community forums, and online feedback forms. Businesses may also interact with customers by messaging through messaging applications.

Messaging typically includes composing and sending electronic messages between two or more computing device users via a communication network. The messages typically include alphanumeric characters, similar to conventional messaging. The messages may also contain interactive elements, including images, Graphics Interchange Formats (GIFs), videos, and interactive icons or buttons.

### SUMMARY

The disclosed systems and methods allow a business to build native, task-focused workflows (e.g., for appointment booking, ride hailing, account log in) that provide rich, interactive ways to engage with customers in message threads of messaging applications.

According to certain aspects of the present disclosure, a computer-implemented method is provided. The computer-implemented method may include receiving a request from a user of a messaging application in a message thread of the messaging application. The messaging application may be associated with a communication network, and the message thread may include the user and a supplier. The computer-implemented method may include displaying to the user, based on the request, a message prompting the user for a confirmation to initiate a transaction with the supplier for an item offered by the supplier. The computer-implemented method may include retrieving, based on the confirmation, a transaction workflow associated with the supplier. The computer-implemented method may include displaying, in the message thread of the messaging application, the transaction workflow in an interactive display.

According to another aspect of the present disclosure, a system is provided. The system may include one or more processors. The system may include a memory storing instructions which, when executed by the one or more processors, cause the system to perform operations. The operations may include to receive a request from a user of a messaging application in a message thread of the messaging application. The messaging application may be associated with a communication network. The message thread may include at least the user and a supplier. The operations may include to display, to the user, based on the request, a message prompting the user for a confirmation to initiate a transaction with the supplier for an item offered by the supplier. The operations may include to retrieve, based on the confirmation, a transaction workflow associated with the supplier. The operations may include to display, in the message thread of the messaging application, the transaction workflow in an interactive display.

According to yet other aspects of the present disclosure, a non-transitory computer-readable storage medium having instructions embodied thereon, the instructions being executable by one or more processors to perform a method, is provided. The method may include providing, by a server of a communication network, to a supplier, a template for configuring a transaction workflow for display in a message thread of a messaging application. The messaging application may be associated with the communication network. The template may include one or more page components with which to configure a blank page, and the template may include one or more preconfigured pages associated with common transaction tasks. The method may include receiving, by the server, from the supplier, the transaction workflow. The method may include storing, by the server, the transaction workflow. The method may include receiving, in the message thread of the messaging application, a request from a user of the messaging application. The message thread may include at least the user and the supplier. The method may include displaying to the user, based on the request, a message prompting the user for a confirmation to initiate a transaction with the supplier for an item offered by the supplier. The method may include retrieving, based on the confirmation, from the server, the transaction workflow associated with the supplier. The transaction workflow may include at least one page including one or more interactive elements for collecting user information. The method may include displaying, in the message thread of the messaging application, the transaction workflow in an interactive display. The method may include displaying to the user, upon a completion of the transaction workflow, a message confirming the completion of the transaction.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a network architecture configured for end-to-end encrypted communication and backup in a messaging platform, according to some embodiments;

FIG. 2 is a block diagram illustrating details of devices and systems used in the network architecture of FIG. 1, according to some embodiments;

FIGS. 3-A and 3-B illustrate an exemplary workflow builder user interface with examples of template blocks and template layouts, according to some embodiments;

FIGS. 4-A, 4-B, and 4-C illustrate a series of screenshots of a mobile device, the screenshots including a transaction workflow start message, pages of the transaction workflow, and a transaction workflow exit message, according to some embodiments;

FIG. 5 is a flowchart illustrating steps in a method for providing a transaction workflow template to a business user of a messaging platform, according to some embodiments;

FIG. 6 is a flowchart illustrating steps in a method for providing a transaction workflow in a message thread including at least a business user of a messaging platform, according to some embodiments; and

FIG. 7 is a block diagram illustrating an exemplary computer system with which mobile phones and other client devices, and the methods in FIGS. 5 and 6, may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

As used herein, a “business” (alternatively, “business entity,” “company,” “retailer,” or “supplier”) may be considered a for-profit entity, a nonprofit entity, or a combination thereof offering a tangible item (e.g., a product), an intangible item (e.g., a service), or a combination thereof for acquisition, attention, or consumption in exchange for a payment or in exchange for no payment.

As used herein, a “customer” may be considered an individual, group, or entity that receives a tangible item (e.g., a product), an intangible item (e.g., a service), or a combination thereof offered by a business.

Customers are having more conversations with businesses than ever before. However, the technology that supports these conversations (e.g., telephone, website chatbots, email, online forums, and online feedback forms) is often outdated. Businesses have scaled up older technology like telephone, leading to call centers, but customers may be required to respond to innumerable prompts (e.g., by pressing number after number) or may be left on hold indefinitely. Alternatively, a customer may open a chat window of a business website only to wait prolonged periods between replies from a business representative or to find the conversation dropped if the customer briefly turns to another task due to the wait. Whichever the case, the cognitive load on customers is tremendous.

The existing technology is limiting for businesses too. Without offering the same rich interactions customers have come to expect from personal conversations—for example, sending photos, sharing locations, adding friends to conversations-businesses cannot best serve customers or develop offerings provided by the business.

Messaging (or “chat”) applications have become an integral part of modern communication, enabling individuals to exchange messages, media, and information with ease. Many businesses have recognized the potential of messaging applications as a direct channel to reach customers, so much so that communicating with businesses via messaging applications has become commonplace. Messaging applications are where individuals update car insurance, find the nearest shoe store, check into flights, arrange food deliveries, manage event planning, consult with medical providers, receive updates from banks, share travel plans, and so on. However, the current state of such interactions in messaging applications often lacks the simplicity, efficiency, and other essential features and capabilities that may enhance the user experience.

Current messaging applications offer basic messaging features, including text, images, and file sharing. But messaging applications are primarily designed for personal, text-based communication, and messaging applications may not provide a useful interface for more complex tasks. Users frequently face limitations such as difficulties in obtaining information about items offered by a business, placing orders or scheduling services, and so on. Therefore, there is a need for improved systems and methods that address these limitations and enhance conversations between customers and businesses within a messaging application.

As disclosed herein, novel systems and methods create mutual benefit for both customers and businesses and revolutionize how customers interact with businesses within messaging applications. This may be achieved by enabling businesses to develop native, task-focused transaction workflows to provide rich, intuitive, interactive ways to securely engage with a customer within a message thread of a messaging application. These workflows may allow a customer to complete tasks like appointment booking, ride hailing, lease signing, food ordering, and so on without leaving the message thread of the messaging application.

Any user-specific information (e.g., personal information, sensitive information, etc.) entered or exchanged in the message thread, including in the workflow, may be end-to-end encrypted (E2EE) and thus may be inaccessible by or hidden to back-end servers or other intermediary system components at all times from transmission to reception of the message by the one or more recipients. E2EE may be understood to broadly include any technique where only the communicating end users may read or decipher the communicated messages, for example, by using cryptographic key(s) to decrypt the conversations.

In some embodiments, via a workflow, a first user (e.g., a customer) of the communication network may want to send a second user (e.g., business) information related to a transaction (e.g., email address, product selection, flight information). The first user may enter the information in the workflow. The information may be encrypted and may then be provided to one or more back-end messaging servers. The one or more back-end messaging servers may identify the second user as the recipient and send the encrypted information to the second user. The message may then be decrypted at the receiving side such that the second user may derive at least information related to the transaction.

All workflows may be subject to back-end review to at least ensure various communication network policies (e.g., data limit policies) are met. For instance, human reviewers may manually review each workflow designed and submitted by a workflow creator (e.g., a business) via a reviewer interface and either approve or reject the workflow based on workflow policy criteria. The approved workflows may be stored and catalogued in one or more back-end storage devices (e.g., server or database).

In other instances, one or more trained machine learning models and/or neural networks may be used, either alone or in conjunction with human reviewers, to approve or reject the submitted workflows. For example, the machine learning model(s) and/or neural network(s) may be trained using datasets that include previously approved or rejected workflows and/or data or information on current workflow policies.

While the end-to-end encryption of the workflow transaction information may be solely facilitated by or implemented on E2EE-based communication networks, it may be understood that any type of communication system (e.g., non-E2EE communication systems, hybrid communication systems including both non-E2EE and E2EE-based systems) may perform the information exchange for cross-platform or cross-system communication as long as the user-specific portions of the information stay encrypted and inaccessible to intermediaries.

### A Note on Data Privacy

The above brief summary is intended to serve as a non-limiting introduction to the concepts discussed in more detail below. However, before discussing further exemplary embodiments, a brief note on data privacy is provided. A more detailed description of the end-to-end encrypted interactive messaging techniques will be addressed in connection with the following Figures.

Some embodiments described herein make use of data or metrics that may include information voluntarily provided by one or more users. In such embodiments, data privacy may be protected in a number of ways.

For example, the user may be required to opt into any data collection before user data may be collected or used. The user may also be provided with the opportunity to opt out of any data collection. Before opting into data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy may be protected in other manners as well. Further details regarding data privacy are discussed below in the section describing network embodiments.

Assuming privacy conditions are satisfied, exemplary embodiments may be deployed in a wide variety of messaging systems, including messaging in a social network or on a mobile device (e.g., through a messaging client application or via short message service), among other possibilities.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

### Example System Architecture

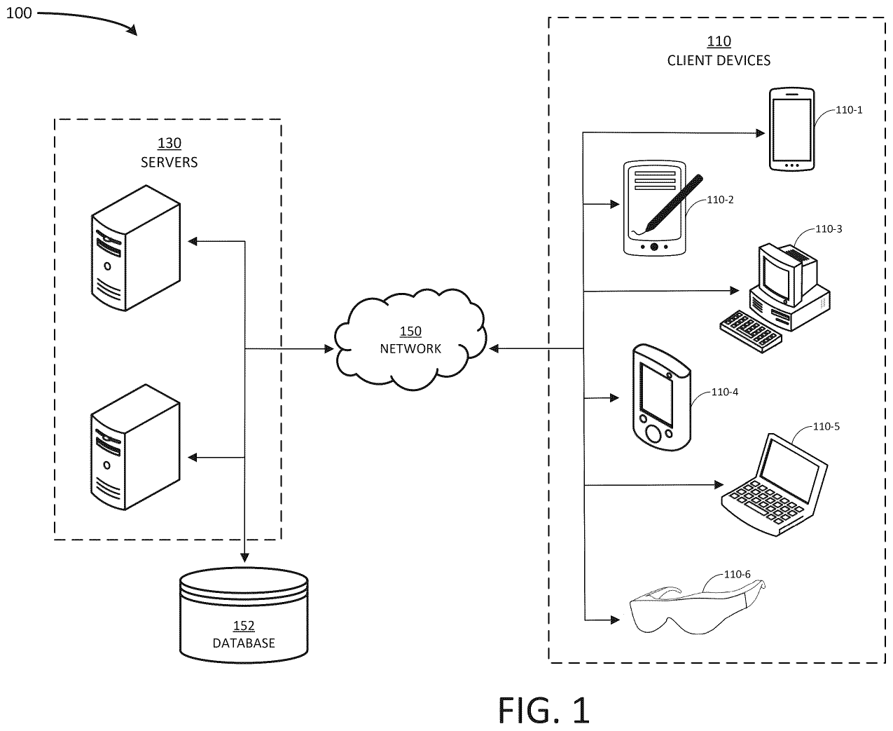

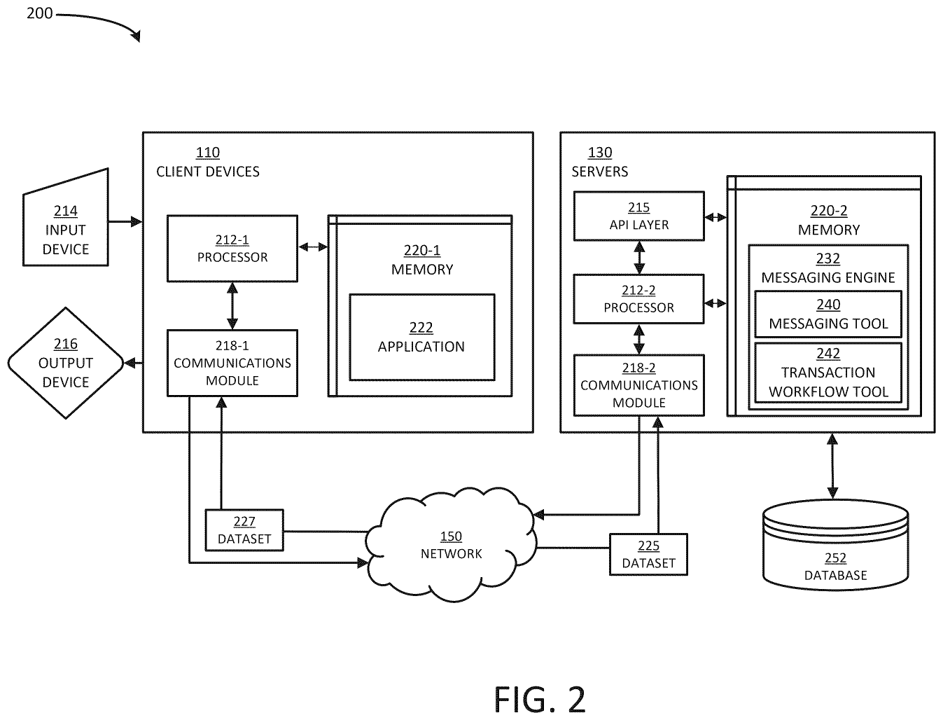

FIG. 1 illustrates a network architecture 100 configured for end-to-end encrypted communication and backup in a messaging platform (e.g., social networking platform, social media platform, standalone messaging platform, instant messaging platform, etc.), according to some embodiments. Network architecture 100 may include a communication network that may be part of or implemented in or as a messaging system or messaging platform. Network architecture 100 may include servers 130 and a database 152, communicatively coupled with multiple client devices 110 via a network 150. Any one of servers 130 may host a messaging application (e.g., application 222 in FIG. 2) running on client devices 110, used by one or more of the participants in a message thread of a networked conversation. It may be understood that network 150 may be a cloud-based network. Furthermore, it may be understood that the configuration of network architecture 100 may not be limited to FIG. 1. For example, it may be possible for the various components to be included, excluded, reside inside, or reside outside the illustrated network 150 or servers 130.

Database 152 may store, at least temporarily, some of the messages and data associated with one or more conversations hosted by the messaging application (e.g., pictures, videos, and other media files). In some embodiments, database 152 may store, at least temporarily, backup files from the conversations, including threads, messages, videos, and metadata. In addition, database 152 may include encrypted keys that may be distributed to each and all of the messaging group participants.

Client devices 110 may include any one of a laptop computer 110-5, a desktop computer 110-3, or a mobile device such as a smartphone 110-1, a palm device 110-4, or a tablet device 110-2. In some embodiments, client devices 110 may include a headset or other wearable device 110-6 (e.g., a virtual reality headset, augmented reality headset, or smart glass), such that at least one participant may be running an immersive reality messaging application installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

Server 130 may include one or more front-end or back-end messaging servers operated by a messaging platform as part of a messaging system. A messaging server may comprise an Internet-accessible server, with network 150 connecting the various devices of the messaging system comprising, at least in part, the Internet. A messaging system may use messaging servers to support messaging for client devices 110.

A user may own or operate a client device 110 that may include a smartphone device 110-1 (e.g., an iPhone® device, an Android® device, a Blackberry® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to the network 150. Smartphone device 110-1 may execute a messaging client, Web browser, or other local application to access the messaging server.

A user may own or operate a client device 110 that may include a tablet device 110-2 (e.g., an iPad® device, an Android® tablet device, a Kindle Fire® device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to the network 150. Tablet device 110-2 may execute a messaging client, Web browser, or other local application to access the messaging server.

The user may own or operate a client device 110 that may include a personal computer device 110-5 (e.g., a Mac OS® device, Windows® device, Linux® device, or other computer device running another operating system). Personal computer device 110-5 may be an Ethernet device capable of connecting to a network 150 via an Ethernet connection. In some embodiments and in some cases, personal computer device 110-5 may additionally or alternatively use cellular, Wi-Fi, or other networking technologies to connect to the network 150. Personal computer device 110-5 may execute a messaging client, Web browser, or other local application to access the messaging server.

A messaging client may be a dedicated messaging client. A dedicated messaging client may be specifically associated with a messaging provider administering the messaging platform, including messaging servers. A dedicated messaging client may be a general client operative to work with a plurality of different messaging providers including the messaging provider administering the messaging platform including the messaging servers.

The messaging client may be a component of an application (e.g., a messaging application) providing additional functionality. For example, a social networking service may provide a social networking application for use on a mobile device for accessing and using the social networking service. The social networking service may include messaging functionality such as may be provided by messaging servers. It will be appreciated that the messaging servers may be one component of a computing device for the social networking service, with the computing device providing additional functionality of the social networking service. Similarly, the social networking application may provide both messaging functionality and additional social networking functionality.

In some cases, a messaging endpoint may retain state between user sessions and in some cases a messaging endpoint may relinquish state between user sessions. A messaging endpoint may use a local store to retain the current state of a message inbox. This local store may be saved in persistent storage such that the state may be retrieved between one session and the next, including situations in which, for example, a local application is quit or otherwise removed from memory (e.g., 220-1 in FIG. 2) or a device is powered off and on again. Alternatively, a messaging endpoint may use a memory cache to retain the current state of a message inbox but refrain from committing the state of the message inbox to persistent storage.

A messaging endpoint that retains the state of a message inbox may comprise a dedicated messaging application or a messaging utility integrated into another local application, such as a social networking application. A messaging endpoint that relinquishes state of a message inbox may comprise messaging access implemented within a Web browser. In one embodiment, a Web browser executing on a client device 110, may execute Hypertext Markup Language 5 (HTML5) code that interacts with the messaging server to present messaging functionality to a user.

A user may send and receive messages from a plurality of devices, including smartphone device 110-1, tablet device 110-2, and personal computer device 110-5. The user may use a first messaging application on the smartphone device 110-1, a second messaging application on the tablet device 110-2, and the Web browser on the personal computer device 110-5. The first and second messaging applications may comprise installations of the same application on both devices. The first and second messaging applications may comprise a smartphone-specific and a tablet-specific version of a common application. The first and second messaging application may comprise distinct applications.

The user may benefit from having a message inbox of the user kept consistent across devices of the user. A user may use a smartphone device 110-1 on the cell system while away from home, sending and receiving messages via the cell system. The user may stop by a coffee shop, or other location offering Wi-Fi, and connect a tablet device 110-2 to a Wi-Fi access point. The tablet device may retrieve the existing known state for the message inbox and receive updates that have happened since the last occasion on which tablet device 110-2 had access to a network, including any messages sent by the smartphone device 110-1 and that may have been received by the user while operating smartphone device 110-1. The user may then return home and access the message inbox using a Web browser on a personal computer device 110-5. The Web browser may receive a snapshot of the current state of the message inbox from the messaging servers due to the Web browser not maintaining or otherwise not having access to an existing state for the message inbox. The Web browser may then retrieve incremental updates for any new changes to the state of the message inbox so long as the Web browser maintains a user session with the messaging servers, discarding the known state for the message inbox at the end of the session, such as when the Web browser is closed by the user. Without limitation, an update may correspond to the addition of a message to a mailbox, a deletion of a message from a mailbox, and a read receipt.

A messaging system may operate by defining a messaging inbox as comprising a plurality of messages, wherein each message may be an individual transaction of communication between two or more participants. A mail server may operate by maintaining a message index for the messaging inbox. Mail servers may receive messages and store the messages in mail archives from which messages may be retrieved through reference to the message index. Mail clients may connect to the mail servers and retrieve messages that have been added to the mail archive since the last update. The mail clients may receive a mail index from the mail archive indicating what messages are stored in the mail archive. The mail clients may compare the mail archive to the current inbox to determine what messages are missing, which the mail clients then request from the mail archive. The mail clients may make changes to the inbox, which results in mail inbox instructions being transmitted to the mail archives instructing the mail archives in modifications to make to the representation of the mail inbox on the mail archives.

Messaging interactions (or “conversations”) mediated by a messaging system may be organized into shared spaces known as message threads. A message thread may collect the messages shared between a particular group of users. Messages sent individually between a pair of users may be collected into a one-on-one message thread uniquely associated with the private messaging between the pair of users. Messages sent between a group of three or more users may not be uniquely defined by the membership of the group, but instead by, in some embodiments, an identifier uniquely identifying the group thread. Membership in a group thread may, in some embodiments, vary over time, adding and/or losing members. Messages in a message thread may be displayed in chronological order by time or date of message posting. Messages in a message thread may be displayed in “question-answer” order, in which one question may be followed by all answers in a hierarchy (e.g., relevance-based hierarchy, popularity-based hierarchy, usefulness-based hierarchy, time- or date-based hierarchy, or the like). Sub-threads may enable a reply to a message to start another thread that remains linked to the original thread.

Messaging interactions may use end-to-end encrypted communication between at least a sending client device (e.g., smartphone device 110-1), one or more back-end messaging servers (e.g., servers 130), and a receiving client device (e.g., desktop computer 110-3). A sending client device may encrypt an outgoing message using security techniques that establish one of only the receiving device being able to decrypt the outgoing message (e.g., by using public-key cryptography) or only the sending and receiving devices being able to decrypt the outgoing message (e.g., by using shared-key cryptography). In these embodiments, the servers 130 of the messaging system may be prevented from decrypting messages being sent between client devices 110. However, in other embodiments, while encrypted communication may be used between the client devices 110 and the servers 130, the servers 130 may be empowered to examine the contents of user messages. Such examination may be used to provide services to the users of the messaging system. In some embodiments, users may be empowered to select whether a particular message thread uses end-to-end encryption (and thereby receive the additional privacy of servers 130 being prevented from examining the contents of messages) or does not (and thereby receive the benefit of the messaging system being able to programmatically examine messages and offer relevant services to the users).

The messaging system may use knowledge generated from interactions in between users. The messaging system may comprise a component of a social-networking system and may use knowledge generated from the broader interactions of the social-networking system. As such, to protect the privacy of the users of the messaging system and the larger social-networking system, the messaging system may include an authorization server (or other suitable component(s)) that allows users to opt in to or opt out of having the actions of a user logged by the messaging system or shared with other systems (e.g., third-party systems), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may be used to enforce one or more privacy settings of the users of the messaging system and other elements of a social-networking system through blocking, data hashing, anonymization, or other suitable techniques as appropriate.

FIG. 2 is a block diagram 200 illustrating details of a client device(s) 110 and a server(s) 130 used in a network architecture as disclosed herein (e.g., network architecture 100), according to some embodiments. A client device 110 and server 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards. Client devices 110 may be coupled with an input device 214 and with an output device 216. Input device 214 may include a keyboard, a mouse, a pointer, or even a touch-screen display that a customer may use to interact with a client device 110. Likewise, output device 216 may include a display and a speaker with which the customer may retrieve results from a client device 110. A client device 110 may also include a processor 212-1, configured to execute instructions stored in a memory 220-1, and to cause a client device 110 to perform at least some of the steps in methods consistent with the present disclosure. Memory 220-1 may further include an application 222. Application 222 includes specific instructions which, when executed by processor 212-1, cause a dataset 227 from server 130 to be displayed for the customer. In some embodiments, application 222 runs on any operating system (OS) installed in a client device 110. In some embodiments, application 222 may run out of a Web browser, installed in a client device 110.

Dataset 227 may include multiple messages and multimedia files provided by one or more participants in a conversation. A participant using a client device 110 may store at least some of the messages and data content in dataset 227 in memory 220-1. In some embodiments, a participant may upload, with a client device 110, a dataset 225 onto server 130, as part of the conversation. Accordingly, dataset 225 may include a message from the participant, or a multimedia file that the participant wants to share in the conversation.

A database 252 may store data and files associated with a conversation from application 222 (e.g., one or more of datasets 225 and 227).

Server 130 includes an application programming interface (API) layer 215, which controls application 222 in each of client devices 110. Server 130 also includes a memory 220-2 storing instructions which, when executed by a processor 212-2, causes server 130 to perform at least partially one or more operations in methods consistent with the present disclosure.

Memory 220-2 includes a messaging engine 232. Messaging engine 232 includes a messaging tool 240 and a transaction workflow tool 242. Messaging tool 240 may be configured to collect messages from datasets 225 sent by multiple client devices 110 during a conversation and provide a feed with a dataset 227 to all client devices 110 for participants in the conversation. Datasets 225 and 227 may include workflows, text messages (including the name of the participant sending the message, and the time), pictures, one-time-view pictures, videos, and other content (e.g., reactions to messages, such as emojis, likes, and others) provided by a participant in the conversation, ordered chronologically. Transaction workflow tool 242 may be configured to provide to a workflow creator (e.g., a business user of a messaging platform), via a workflow builder user interface (UI) (e.g., 300), a library of workflow templates, including template blocks (e.g., 312) and template layouts (e.g., 318), that may be created or maintained by a messaging platform and stored in database 252. The workflow creator may use the workflow templates to develop a workflow and may submit, by API layer 215, a completed workflow to database 252. In some embodiments, transaction workflow tool 242 may review for approval or rejection the submitted workflows using one or more machine learning models or neural networks alone or in conjunction with a human review process. Once a submitted workflow has been approved for implementation, transaction workflow tool 242 may determine which workflow to provide to a messaging platform user (e.g., a customer) in a message thread with the workflow creator (e.g., the business user of the messaging platform).

Processors 212-1 and 212-2, and memories 220-1 and 220-2 will be collectively referred to, hereinafter, as “processors 212” and “memories 220,” respectively.

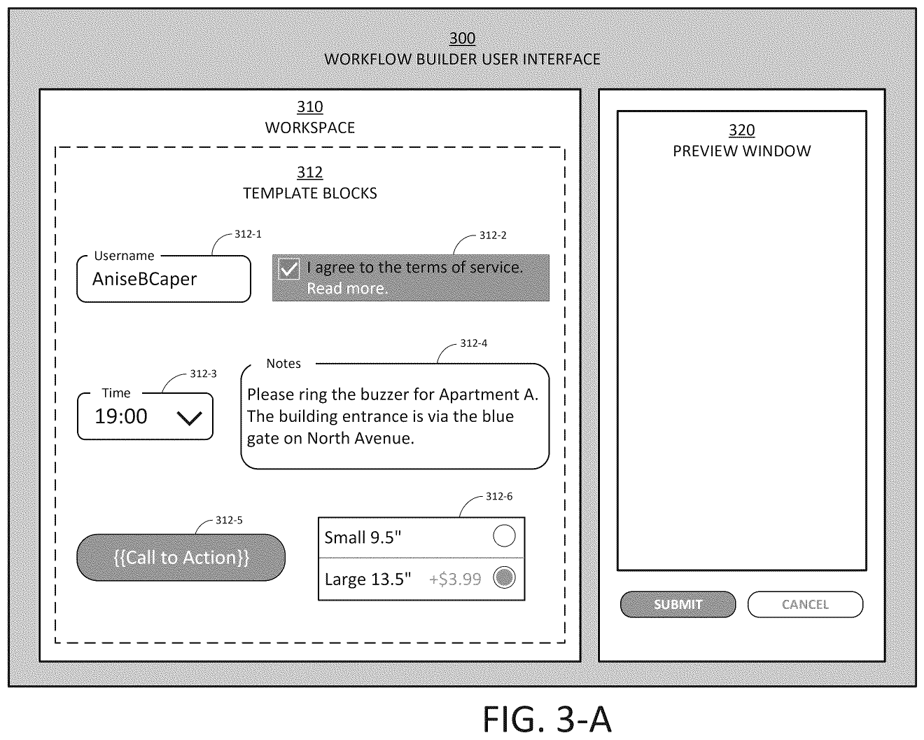

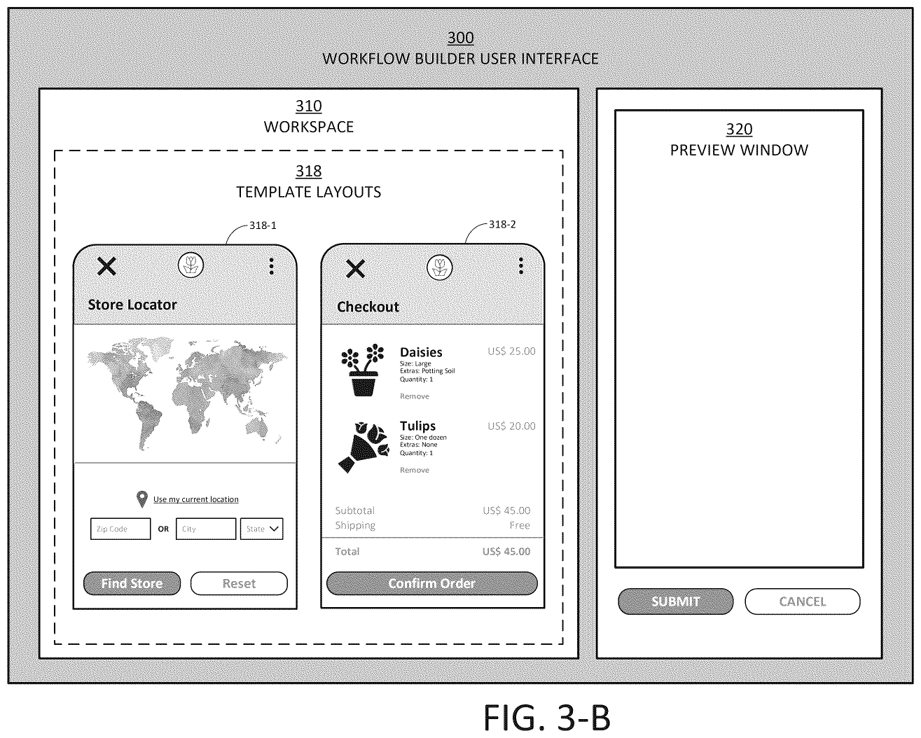

As shown, network architecture 100 and the components detailed above may at least support transaction workflow creation, review, and implementation. For example, workflow builder user interface (UI) 300 (see FIGS. 3-A and 3-B) may be used by a workflow creator (e.g., business user of the messaging platform) to build a workflow by assembling or configuring template blocks 312 or template layouts 318 provided by the messaging platform. Workflow builder UI 300 may be used to create different types of workflows having different content, each of which may be used for different transaction purposes. Upon creation of each workflow, the workflow may be submitted to database 252 via API layer 215. In examples, database 252 may organize or catalogue all workflows such that the workflows may be associated with the correct creators. For example, workflows may be organized under creator identifiers (IDs) or a specific subject or category.

Each of the submitted workflows may then be sent or pushed to a review queue, which may allow a human reviewer (e.g., messaging platform employee or representative) to review (e.g., via a reviewer UI) a workflow to determine whether the workflow conforms to one or more policies of the messaging platform. For example, if the formatting violates uniformity standards or the content violates data limit policies, the human reviewer may reject the workflow. In other examples, the review may be performed by one or more machine learning models or neural networks alone or in conjunction with the human review process. The machine learning model(s) or the neural network(s) may be trained using various types of training datasets that include examples of conforming workflows, rejected workflows, and data or information related to why the workflows were accepted or rejected (e.g., which workflow policies were implicated or violated). As workflows are accepted or rejected, database 252 may be updated in real time or near real time (e.g., rejected workflows may be removed from database 252).

FIGS. 3-A and 3-B illustrate an exemplary workflow builder user interface (UI) 300 with examples of template blocks 312-1 to 312-6 (hereinafter, collectively referred to as “template blocks 312”) and template layouts 318-1 and 318-2 (hereinafter, collectively referred to as “template layouts 318”), according to some embodiments. In some embodiments, template blocks 312 and template layouts 318 may be selected from a workflow template library stored in database 252.

Workflow builder UI 300 includes a workspace 310, where template blocks 312 and template layouts 318 may be edited or configured, and a preview window 320, where at least one workflow page may be previewed. In some embodiments, workspace 310 may include a textual user interface for editing source code. In some embodiments, workspace 310 may include a graphical user interface, including options to move or to drag-and-drop template blocks 312 or template layouts 318 to different areas of workspace 310 or preview window 320. In some embodiments, workspace 310 may include both textual and graphical aspects for editing or configuring a workflow. In some embodiments, changes made in workspace 310 may be automatically rendered and displayed in preview window 320. In some embodiments, changes made in workspace 310 may be rendered and displayed in preview window 320 upon a request by a workflow creator. The workflow preview displayed in preview window 320 may be similar to or substantially the same as the workflow a customer would see when rendered and displayed on the computing device of the customer. Once a workflow is finalized, a workflow creator may submit the workflow (e.g., by selecting or pressing the “Submit” icon), which causes the workflow to be pushed to a review queue and in front of a reviewer (either human or artificial) as described above.

In some embodiments, a workflow creator may use workflow builder UI 300 on a computing device (e.g., client devices 110) to generate a workflow. A workflow creator may be a business user of a messaging platform (e.g., a consulting firm, a landscaping company, a food bank). Workflows may be created for tasks related to the business (e.g., product purchasing, service availability searching, business locating), and may be provided in a message thread of a messaging application (e.g., application 222) of a messaging platform. It may be understood that both the business (the workflow creator) and the customer may be users of the messaging platform. It may be further understood that the workflows may be the structure or framework for providing at least the back-end messaging components (e.g., back-end servers) the necessary information to allow users of the messaging platform to message interactively.

As shown in FIG. 3-A, a workflow creator may customize template blocks 312 of a workflow template, such as a username template block 312-1, a terms-of-service template block 312-2, a time template block 312-3, a notes template block 312-4, an interactive button template block 312-5, and a selection picker template block 312-6. Template blocks 312 may be the basic components that make up a page (e.g., text fields, selection pickers, images). A workflow creator may begin with a blank workflow page and assemble template blocks 312 to build the page. In some embodiments, the title of a template block 312 (e.g., “Username,” “Time,” “Notes”) or the content of a template block 312 (e.g., text, images, video, checkboxes) may be managed by the messaging platform (e.g., the title of a template block may be limited to specific text fonts, text colors, text sizes, or the like, or to a maximum number of characters, and the content of a template block may be limited to include only text or only images).

In some embodiments, various interactive icons and buttons (e.g., interactive button template block 312-5) may be configured to perform different functions. For example, the workflow creator may customize a first button to read “Call Us,” and the button may allow a customer to call a phone number associated with the business. In another example, a second button may be configured such that, when pressed or selected, the recipient may be hyperlinked to a website (e.g., a website associated with the business). In another example, a third button may be configured to hyperlink the recipient to a “help center” webpage. In some embodiments, the workflow creator may be required to provide the actual phone numbers or Uniform Resource Locators (URLs) for review by the messaging platform to ensure the phone numbers or URLs meet anti-spamming policies.

As shown in FIG. 3-B, a workflow creator may customize template layouts 318, such as Store Locator template layout 318-1 and Checkout template layout 318-2. A template layout 318 may be a pre-assembled page that a workflow creator may “take off the shelf” and, with less time or effort than may be required when starting from a blank page and assembling template blocks 312, configure as required and integrate into a workflow. In some embodiments, template layouts 318 may be designed for specialized or for common tasks (e.g., log-in, seat selection, product listing, checkout, payments). For example, in Store Locator template layout 318-1, a workflow creator may be required to provide only a logo (e.g., an image of a flower) for a logo template block and a list of store locations. In a further example, in Checkout template layout 318-2, a workflow creator may be required to provide only a logo (e.g., an image of a flower) for a logo template block.

In some embodiments, the information provided by a customer in one of the editable fields (e.g., name, physical address, email address, patient identification number, driving license number) may be specific to the customer and potentially sensitive. All such information may be required to be end-to-end encrypted via a secure data channel as the information is sent between the business and the customer.

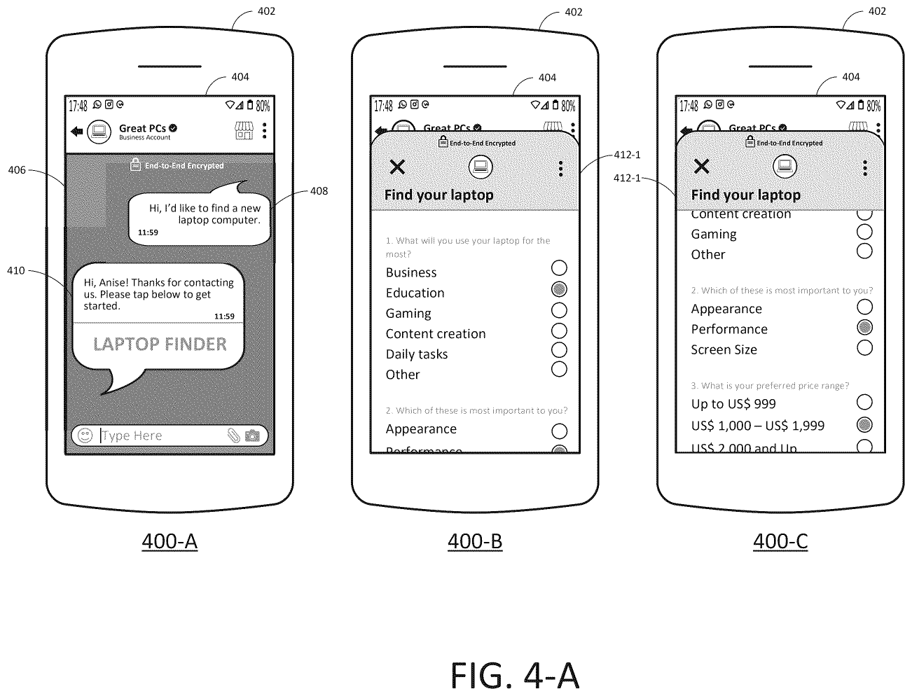

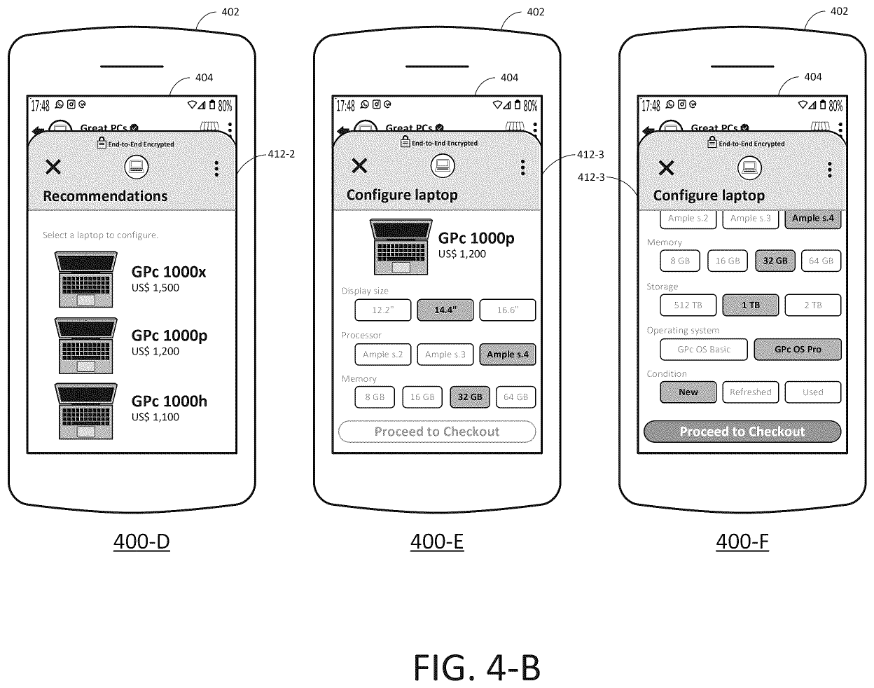

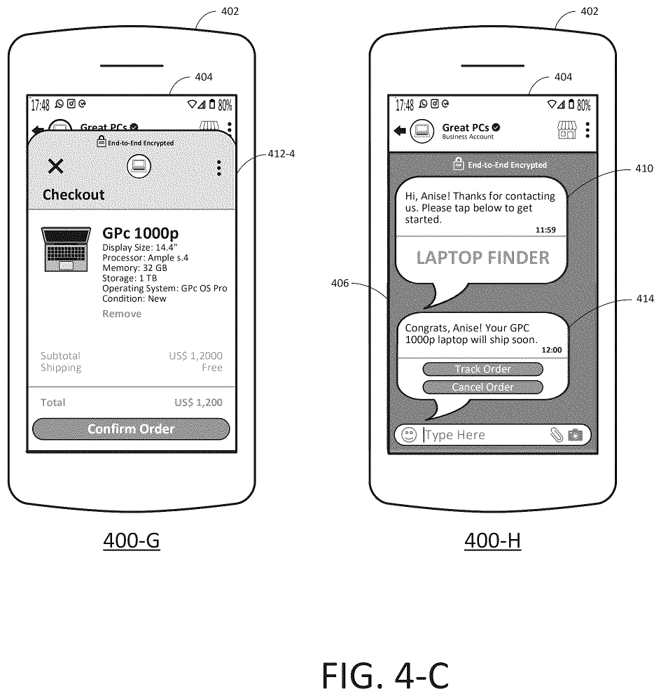

FIGS. 4-A, 4-B, and 4-C illustrate a series of screenshots 400-A to 400-H (hereinafter, collectively referred to as “screenshots 400”) of a mobile device 402, the screenshots 400 including a workflow start message 410, pages 412-1 to 412-4 of the transaction workflow (hereinafter, collectively referred to as “workflow 412”), and a workflow exit message 414, according to some embodiments. Screenshots 400 include messaging application 404, message thread 406, customer request message 408, workflow start message 410, workflow 412, and workflow exit message 414.

As shown in screenshot 400-A, on mobile device 402, a customer may open messaging application 404 of a messaging platform and select a business (e.g., Great PCs) with which to exchange messages. In message thread 406 of messaging application 404, the customer and the business may exchange secure messages by end-to-end encryption. In message thread 406, the customer may enter customer request message 408 (e.g., “Hi, I'd like to find a new laptop computer.”). Based on the content of customer request message 408, the customer may be prompted with workflow start message 410 (e.g., “Hi, Anise! Thanks for contacting us. Please tap below to get started.”). Upon the customer selecting, pressing, or otherwise appropriately following the prompt of workflow start message 410 (e.g., by tapping “LAPTOP FINDER”), an appropriate workflow may open within message thread 406.

In some embodiments, upon receiving customer request message 408, the business may ask the customer one or more follow-up questions before prompting the user with workflow start message 410. For example, a customer looking for a new laptop computer may be asked whether the customer currently owns a laptop, what condition the current laptop is in, or whether the customer intends to keep, resell, recycle, or scrap the current laptop. Based on the responses of the customer to the follow-up questions, the appropriate workflow with which to provide the customer may be determined.

As shown in screenshots 400-B to 400-G, a customer may complete a transaction with the business by entering the appropriate information to proceed through workflow 412. In the example workflow shown in screenshots 400-B to 400-G, a customer looking for a new laptop computer is first prompted with “Find your laptop” workflow page 412-1. Screenshots 400-B and 400-C show a list of questions through which the customer may scroll to select responses, which may be used to determine which of the products of the business may suit the user. Next, as shown in screenshot 400-D, the customer is prompted with “Recommendations” workflow page 412-2 based on the responses in the previous page. The recommendations include three laptop computers, and the user is prompted to select a laptop to configure. Next, as shown in screenshots 400-E and 400-F, the customer is prompted with “Configure laptop” workflow page 412-3, in which the customer is provided with a series of options to scroll through to choose configuration options for the computer selected in the previous page. Once all configuration choices have been made, the “Proceed to Checkout” button becomes active and selectable by the customer. Next, as shown in screenshot 400-G, the customer is prompted with “Checkout” workflow page 412-4, where the customer may review the laptop order and may finalize the laptop order by selecting the “Confirm Order” button.

In some embodiments, a customer may return to a previous page of a workflow 412 to review or edit selections or responses. In some embodiments, a user may exit workflow 412, whether intentionally (e.g., by selecting an exit icon or button in workflow 412) or unintentionally, and may be prompted with a workflow start message 410 that may allow the user to choose whether to start workflow 412 from the beginning or to resume workflow 412 from the point at which the user left off. In some embodiments, with a first workflow open, a second workflow may be opened when a customer appropriately interacts with a selectable text, icon, or button or otherwise enters appropriate information (e.g., in a text field) in the first workflow.

As shown in screenshot 400-H, upon the closing of a workflow, a customer may be prompted by the business with workflow exit message 414 (e.g., “Congrats, Anise! Your GPC 1000p laptop will ship soon.”). In the example shown, workflow exit message 414 includes two interactive buttons-labeled “Track Order” and “Cancel Order”-associated with the completion of a laptop transaction.

In some embodiments, the workflow may be closed automatically upon the completion of a transaction (e.g., the purchase of a laptop). In some embodiments, the workflow may be closed upon an intentional request (e.g., tapping an exit icon or button in workflow 412) or an unintentional request by the customer. In some embodiments, a customer may be prompted by the business with workflow exit message 414 only upon the automatic close of the workflow following completion of the workflow (e.g., completion of a transaction). In some embodiments, a customer may be prompted by the business with workflow exit message 414 upon the automatic close of the workflow following completion of the workflow or upon the close of the workflow following a request by the user.

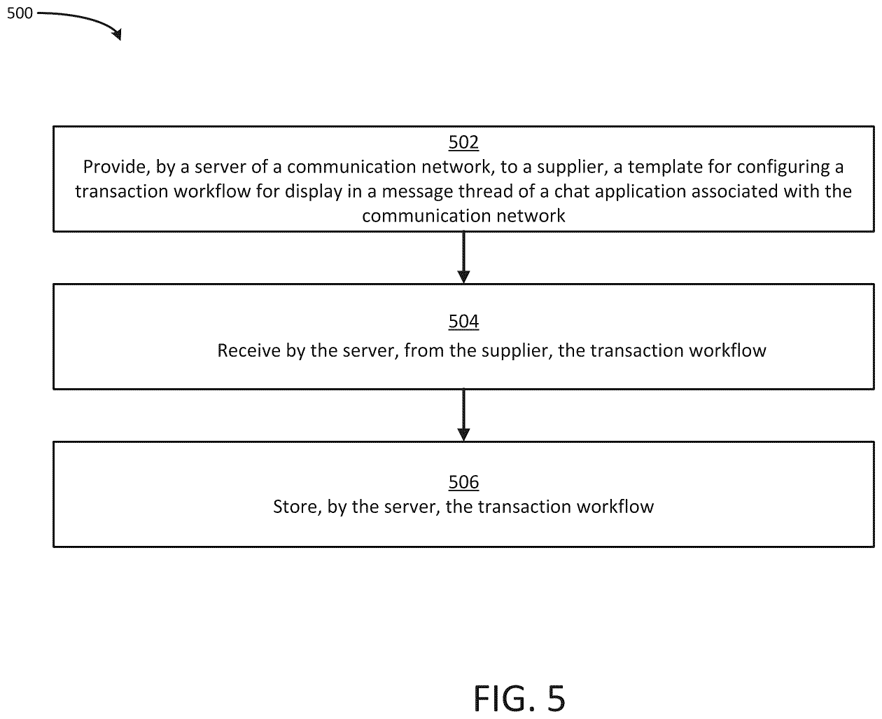

FIG. 5 is a flowchart illustrating steps in a method 500 for providing a transaction workflow template to a business user of a messaging platform, according to some embodiments. In some embodiments, methods as disclosed herein may include one or more steps in method 500 performed by a processor circuit executing instructions stored in a memory circuit, in a client device, a remote server or a database, communicatively coupled through a network (e.g., processors 212, memories 220, client devices 110, server 130, databases 152 and 252, and network 150). In some embodiments, one or more of the steps in method 500 may be performed by a messaging engine including a messaging tool and a transaction workflow tool, as disclosed herein (e.g., messaging engine 232, messaging tool 240, and transaction workflow tool 242). In some embodiments, methods consistent with the present disclosure may include at least one or more steps as in method 500 performed in a different order, simultaneously, quasi-simultaneously, or overlapping in time.

Step 502 includes providing, by a server of a communication network, to a supplier, a template for configuring a transaction workflow for display in a message thread of a messaging application associated with the communication network. In some embodiments of Step 502, the communication network may be part of or implemented in or as a messaging platform (e.g., social networking platform, social media platform, standalone messaging platform, instant messaging platform, etc.). In some embodiments of Step 502, the supplier may be a business user of a messaging platform (e.g., a consulting firm, a landscaping company, a food bank). In some embodiments of Step 502, a workflow includes at least one page of one or more interactive elements for collecting user (e.g., customer) information for a transaction with a business. In some embodiments of Step 502, a template may include one or more page components with which to configure a blank page (e.g., template blocks 312); and one or more preconfigured pages associated with common transaction tasks (e.g., template layouts 318). In some embodiments of Step 502, a supplier may construct a workflow, using the templates, in a workflow builder user interface (UI) (e.g., 300).

Step 504 includes receiving, by the server, from the supplier, the transaction workflow. In some embodiments of Step 504, the workflow includes one or more pages of a workflow created by and submitted by a supplier. In some embodiments of Step 504, the one or more pages of a submitted workflow include one or more pages of a workflow that has been previously received at the server, the one or more pages having been revised to update, correct, replace, or the like, the one or more pages previously received at the server. In some embodiments of Step 504, the workflow previously received at the server may have not yet been reviewed by a messaging platform for implementation on the messaging platform. In some embodiments of Step 504, the workflow previously received at the server may have been reviewed and rejected by a messaging platform for implementation on the messaging platform. In some embodiments of Step 504, the workflow previously received at the server may have been reviewed and approved by a messaging platform for implementation on the messaging platform. In some embodiments of Step 504, a workflow received at the server may be either approved or rejected based on workflow policy criteria. In some embodiments of Step 504, one or more trained machine learning models and/or neural networks may be used, either alone or in conjunction with human reviewers, to approve or reject the workflow received by the server. For example, the machine learning model(s) and/or neural network(s) may be trained using datasets that include previously approved or rejected workflows and/or data or information on current workflow policies.

Step 506 includes storing, by the server, the transaction workflow. In some embodiments of Step 506, the workflow may have been reviewed and approved for implementation on a messaging platform. In some embodiments of Step 506, the workflow may be stored or catalogued in a database that may be included, excluded, reside inside, or reside outside the server.

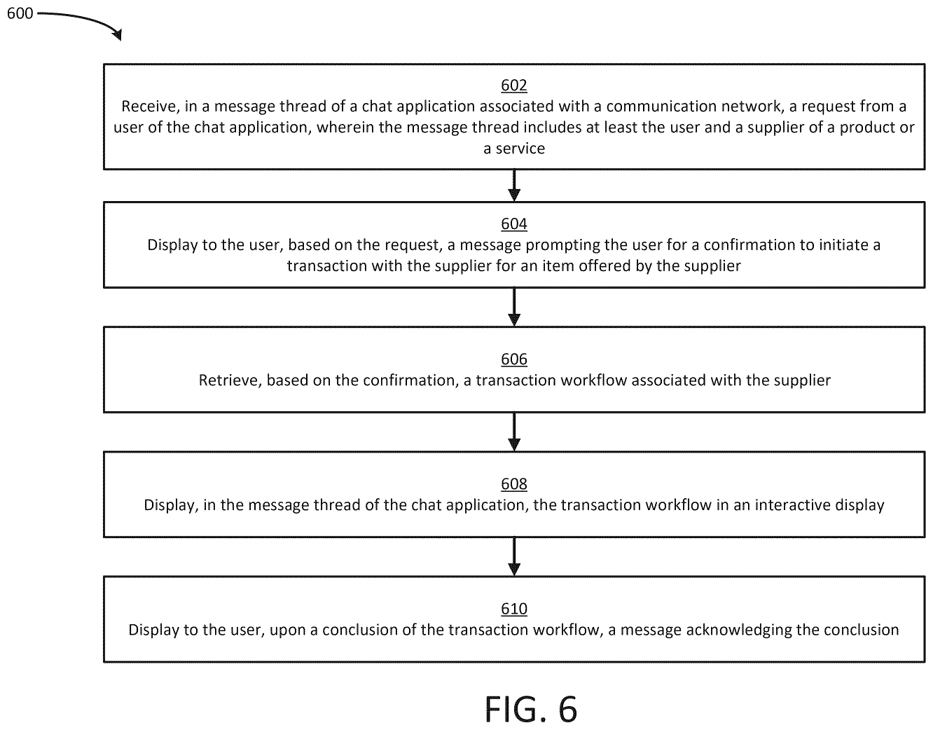

FIG. 6 is a flowchart illustrating steps in a method 600 for providing a transaction workflow in a message thread including at least a business user of a messaging platform, according to some embodiments. In some embodiments, methods as disclosed herein may include one or more steps in method 600 performed by a processor circuit executing instructions stored in a memory circuit, in a client device, a remote server or a database, communicatively coupled through a network (e.g., processors 212, memories 220, client devices 110, servers 130, databases 152 and 252, and network 150). In some embodiments, one or more of the steps in method 600 may be performed by a messaging engine including a messaging tool and a transaction workflow tool, as disclosed herein (e.g., messaging engine 232, messaging tool 240, and transaction workflow tool 242). In some embodiments, methods consistent with the present disclosure may include at least one or more steps as in method 600 performed in a different order, simultaneously, quasi-simultaneously, or overlapping in time.

Step 602 includes receiving, in a message thread of a messaging application associated with a communication network, a request from a user of the messaging application, wherein the message thread includes at least the user and a supplier. In some embodiments of Step 602, the communication network may be part of or implemented in or as a messaging platform (e.g., social networking platform, social media platform, standalone messaging platform, instant messaging platform, etc.). In some embodiments of Step 602, the supplier may be a business user of a messaging platform (e.g., a consulting firm, a landscaping company, a food bank). In some embodiments of Step 602, the user may be a customer. In further embodiments of Step 602, the request may indicate the customer wishes to engage in a transaction with the business. In some embodiments, Step 602 may include enabling an encrypted communication channel between the user and the supplier. In some embodiments of Step 602, the communication channel between the user and the supplier may be end-to-end encrypted.

Step 604 includes displaying to the user, based on the request, a message prompting the user for a confirmation to initiate a transaction with the supplier for an item offered by the supplier. In some embodiments of Step 604, the confirmation may include a command, by the user, with a client device hosting the messaging application (e.g., tapping an icon displayed on a graphical user interface (GUI) of the client device, pressing a physical button on the client device, shaking the client device, etc.).

Step 606 includes retrieving, based on the confirmation, a transaction workflow associated with the supplier. In some embodiments of Step 606, a workflow may include at least one page of one or more interactive elements for collecting user (e.g., customer) information for a transaction with a business. In some embodiments of Step 606, the workflow may have been constructed by the supplier, using workflow templates, in a workflow builder user interface (UI) (e.g., 300). In further embodiments of Step 606, a template may include one or more page components with which to configure a blank page (e.g., template blocks 312); and one or more preconfigured pages associated with common transaction tasks (e.g., template layouts 318). In some embodiments of Step 606, the workflow may have been reviewed and approved for implementation in the communication network.

Step 608 includes displaying, in the message thread of the messaging application, the transaction workflow in an interactive display. In some embodiments of Step 608, one or more pages of the workflow may partially fill or completely fill the area of the interactive display including the message thread or the messaging application. In some embodiments of Step 608, the workflow may be minimized, maximized, or otherwise resized or relocated within the display based on a request from the user or based on a state of the messaging application (e.g., foregrounded, backgrounded, open, closed, active, inactive, etc.).

Step 610 includes displaying to the user, upon a conclusion of the transaction workflow, a message acknowledging the conclusion. In some embodiments of Step 610, the message may be displayed in the message thread of the messaging application. In some embodiments of Step 610, the message may be displayed in a page of the workflow. In some embodiments of Step 610, the conclusion of the workflow includes the successful completion of the transaction between the user and the supplier. In some embodiments of Step 610, the conclusion of the workflow includes the unsuccessful completion of the transaction between the user and the supplier.

### Hardware Overview

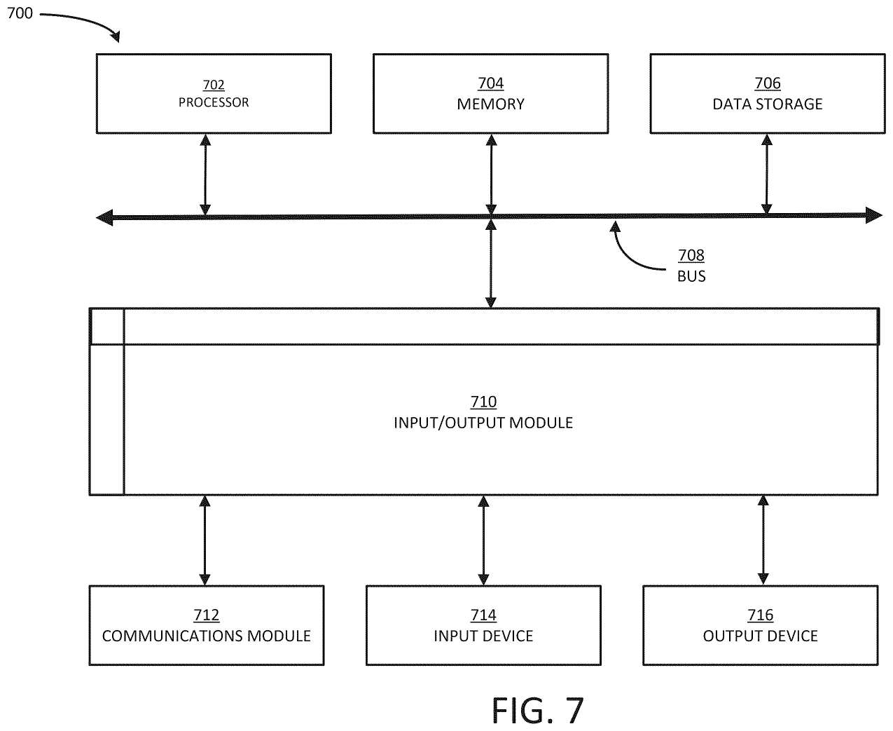

FIG. 7 is a block diagram illustrating an exemplary computer system 700 with which mobile phones and other client devices, and the methods in FIGS. 5 and 6, may be implemented, according to some embodiments. In certain aspects, the computer system 700 may be implemented using hardware or a combination of software and hardware, either in a dedicated server, or integrated into another entity, or distributed across multiple entities.

Computer system 700 (e.g., client devices 110 and servers 130) includes a bus 708 or other communication mechanism for communicating information, and a processor 702 (e.g., processors 212) coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 700 may include, in addition to hardware, code that creates an execution environment for the computer program in question, e.g., code that constitutes processor firmware, a protocol stack, a database management system, an operating system, or a combination of one or more of them stored in an included memory 704 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 may be supplemented by, or incorporated in, special purpose logic circuitry.

The instructions may be stored in the memory 704 and implemented in one or more computer program products, e.g., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. Input/output module 710 may be any input/output module. Exemplary input/output modules 710 include data ports such as Universal Serial Bus (USB) ports. The input/output module 710 may be configured to connect to a communications module 712. Exemplary communications modules 712 (e.g., communications modules 218) include networking interface cards, such as Ethernet cards and modems. In certain aspects, input/output module 710 may be configured to connect to a plurality of devices, such as an input device 714 (e.g., input device 214) and/or an output device 716 (e.g., output device 216). Exemplary input devices 714 include a keyboard and a pointing device, e.g., a mouse or a trackball, by which a user may provide input to the computer system 700. Other kinds of input devices 714 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 716 include display devices, such as an LCD (liquid crystal display) monitor, for displaying information to the user.

According to one aspect of the present disclosure, the client devices 110 and servers 130 may be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 700 may include clients and servers. A client and server may be generally remote from each other and typically interact through a communication network. The relationship of client and server arises by virtue of computer programs running on the respective computers and having a client-server relationship to each other. Computer system 700 may be, for example, and without limitation, a desktop computer, laptop computer, or tablet computer. Computer system 700 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires forming bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

What is claimed is:

1. A computer-implemented method, comprising:
receiving, in a message thread of a messaging application associated with a communication network, a request from a user of the messaging application, wherein the message thread includes at least the user and a supplier;
displaying to the user, based on the request, a message prompting the user for a confirmation to initiate a transaction with the supplier for an item offered by the supplier;
retrieving, based on the confirmation, a transaction workflow associated with the supplier; and
displaying, in the message thread of the messaging application, the transaction workflow in an interactive display.

2. The computer-implemented method of claim 1, wherein the transaction workflow comprises at least one page including one or more interactive elements for collecting user information.

3. The computer-implemented method of claim 1, further comprising providing, to the supplier, a template for configuring the transaction workflow.

4. The computer-implemented method of claim 3, wherein the template comprises:
one or more page components with which to configure a blank page; and
one or more preconfigured pages associated with common transaction tasks.

5. The computer-implemented method of claim 1, further comprising receiving, by a server of the communication network, from the supplier, the transaction workflow.

6. The computer-implemented method of claim 1, further comprising storing, by a server of the communication network, the transaction workflow.

7. The computer-implemented method of claim 1, further comprising enabling an encrypted communication channel between the user and the supplier.

8. The computer-implemented method of claim 1, wherein the confirmation comprises a command, by the user, with a client device hosting the messaging application.

9. The computer-implemented method of claim 1, further comprising displaying to the user, upon a conclusion of the transaction workflow, a message acknowledging the conclusion.

10. A system, comprising:
one or more processors; and
a memory storing instructions which, when executed by the one or more processors, cause the system to:
receive, in a message thread of a messaging application associated with a communication network, a request from a user of the messaging application, wherein the message thread includes at least the user and a supplier;
display, to the user, based on the request, a message prompting the user for a confirmation to initiate a transaction with the supplier for an item offered by the supplier;
retrieve, based on the confirmation, a transaction workflow associated with the supplier; and
display, in the message thread of the messaging application, the transaction workflow in an interactive display.

11. The system of claim 10, wherein the transaction workflow comprises at least one page including one or more interactive elements for collecting user information.

12. The system of claim 10, wherein the one or more processors further execute instructions to provide, to the supplier, a template for configuring the transaction workflow.

13. The system of claim 12, wherein the template comprises:
one or more page components with which to configure a blank page; and
one or more preconfigured pages associated with common transaction tasks.

14. The system of claim 10, wherein the one or more processors further execute instructions to receive, by a server of the communication network, from the supplier, the transaction workflow.

15. The system of claim 10, wherein the one or more processors further execute instructions to store, by a server of the communication network, the transaction workflow.

16. The system of claim 10, wherein the one or more processors further execute instructions to enable an encrypted communication channel between the user and the supplier.

17. The system of claim 10, wherein the confirmation comprises a command, by the user, with a client device hosting the messaging application.

18. The system of claim 10, wherein the one or more processors further execute instructions to display to the user, upon a conclusion of the transaction workflow, a message acknowledging the conclusion.

19. A non-transitory computer-readable storage medium having instructions embodied thereon, the instructions being executable by one or more processors to perform a method, the method comprising:
providing, by a server of a communication network, to a supplier, a template for configuring a transaction workflow for display in a message thread of a messaging application associated with the communication network, the template comprising:
one or more page components with which to configure a blank page; and
one or more preconfigured pages associated with common transaction tasks;
receiving, by the server, from the supplier, the transaction workflow;
storing, by the server, the transaction workflow;
receiving, in the message thread of the messaging application, a request from a user of the messaging application, wherein the message thread includes at least the user and the supplier;
displaying to the user, based on the request, a message prompting the user for a confirmation to initiate a transaction with the supplier for an item offered by the supplier;
retrieving, based on the confirmation, from the server, the transaction workflow associated with the supplier, the transaction workflow comprising at least one page including one or more interactive elements for collecting user information;
displaying, in the message thread of the messaging application, the transaction workflow in an interactive display; and
displaying to the user, upon a conclusion of the transaction workflow, a message acknowledging the conclusion.

20. The non-transitory computer-readable storage medium of claim 19, further comprising enabling an encrypted communication channel between the user and the supplier.
